(19) United States
(12) Patent Application Publication
(10) Pub. No.: US 2023/0030471 A1
(43) Pub. Date: Feb. 2, 2023

(54) TEXT PROCESSING METHOD AND APPARATUS, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Jiaxiang LIU, Beijing (CN); Shikun FENG, Beijing (CN)

(73) Assignee: BEIJING BAIDU NETCOM SCIENCE TECHNOLOGY CO., LTD., Beijing (CN)

(21) Appl. No.: 17/698,242

(22) Filed: Mar. 18, 2022

(30) Foreign Application Priority Data
Jul. 29, 2021 (CN) 202110861985.7

(51) Int. Cl. G06F 40/284

(52) U.S. Cl. CPC G06F 40/284

(57) ABSTRACT

The present disclosure provides a text processing method and apparatus, an electronic device and a storage medium, and relates to the field of artificial intelligence technologies such as deep learning and natural language processing. The method may include: configuring, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1; and processing the text by using the Transformer model. Model performance and a corresponding text processing effect can be improved by using the solutions according to the present disclosure.

### CROSS-REFERENCE TO RELATED APPLICATIONS

The present application claims the priority of Chinese Patent Application No. 202110861985.7, filed on Jul. 29, 2021, with the title of “TEXT PROCESSING METHOD AND APPARATUS, ELECTRONIC DEVICE AND STORAGE MEDIUM.” The disclosure of the above application is incorporated herein by reference in its entirety.

### TECHNICAL FIELD

The present disclosure relates to the field of artificial intelligence technologies, and, in particular, to a text processing method and apparatus, an electronic device and a storage medium in the fields such as deep learning and natural language processing.

### BACKGROUND

In practical applications, pre-processing, such as machine translation or emotion recognition, for a to-be-processed text may be realized by means of a Transformer model.

The Transformer model generally adopts a multi-head-attention mechanism, which includes multiple attention modules and has high time complexity. Moreover, the time complexity may increase with an increase in a text length. The text length generally refers to a number of tokens.

In order to reduce the time complexity and improve the efficiency of text processing, a computational sparsity method, such as a sparse self-attention (Longformer) method, may be adopted. However, in this method, each head adopts a same attention pattern, which affects model performance and reduces a text processing effect.

### SUMMARY

The present disclosure provides a text processing method and apparatus, an electronic device and a storage medium.

A text processing method includes configuring, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1; and processing the text by using the Transformer model.

An electronic device includes at least one processor; and a memory communicatively connected with the at least one processor; wherein the memory stores instructions executable by the at least one processor, and the instructions are executed by the at least one processor to enable the at least one processor to perform a text processing method, wherein the text processing method includes: configuring, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1; and processing the text by using the Transformer model.

A non-transitory computer readable storage medium with computer instructions stored thereon, wherein the computer instructions are used for causing a computer to perform a text processing method, wherein the text processing method includes configuring, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1; and processing the text by using the Transformer model.

One of the embodiments disclosed above has the following advantages or beneficial effects. The heads no longer adopt the same attention pattern, but different heads may correspond to different attention patterns, so as to improve connectivity between tokens, thereby improving the model performance and correspondingly improving the text processing effect.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The drawings are intended to provide a better understanding of the solutions and do not constitute limitations on the present disclosure. In the drawings,

FIG. 1 is a flowchart of an embodiment of a text processing method according to the present disclosure;

FIG. 2 is a flowchart of an embodiment of a method for configuring global patterns corresponding to heads respectively according to the present disclosure;

FIG. 3 is a schematic diagram of attention patterns corresponding to different heads according to the present disclosure;

FIG. 4 is a schematic structural diagram of composition of an embodiment of a text processing apparatus 400 according to the present disclosure; and

FIG. 5 is a schematic block diagram of an electronic device 500 configured to implement embodiments of the present disclosure.

### DETAILED DESCRIPTION

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

In addition, it is to be understood that the term “and/or” herein is merely an association relationship describing associated objects, indicating that three relationships may exist. For example, A and/or B indicates that there are three cases of A alone, A and B together, and B alone. Besides, the character “/” herein generally means that associated objects before and after it are in an “or” relationship.

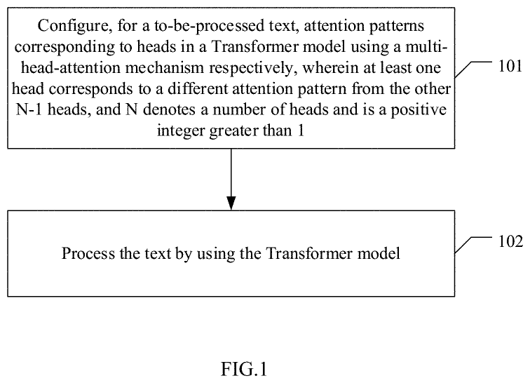

FIG. 1 is a flowchart of an embodiment of a text processing method according to the present disclosure. As shown in FIG. 1, the method includes the following specific implementation.

In step 101, for a to-be-processed text, attention patterns corresponding to heads in a Transformer model using a multi-head-attention mechanism are configured respectively, wherein at least one head corresponds to a different attention pattern from the other N−1 heads, and N denotes a number of heads and is a positive integer greater than 1.

In step 102, the text is processed by using the Transformer model.

As can be seen, in the solution of the above method embodiment, the heads no longer adopt the same attention pattern, but different heads may correspond to different attention patterns, so as to improve connectivity between tokens, thereby improving the model performance and correspondingly improving the text processing effect.

The specific value of N may be determined according to an actual requirement. Corresponding attention patterns may be configured for N heads respectively. At least one head corresponds to a different attention pattern from the other N−1 heads. That is, N attention patterns corresponding to the N heads include at least two different attention patterns.

In one embodiment of the present disclosure, the attention pattern may include: a local pattern and a global pattern. That is, the attention pattern may be composed of a local pattern and a global pattern. The local pattern may also be called a local attention, and the global pattern may also be called a global attention.

In one embodiment of the present disclosure, the heads may correspond to a same local pattern. That is, a uniform local pattern may be configured for the heads. In this way, an effect of configuring different attention patterns may be achieved only by configuring different global patterns for any two heads, thereby simplifying the configuration process and improving the processing efficiency.

In one embodiment of the present disclosure, the heads may correspond to different global patterns respectively, wherein change rules between the global patterns corresponding to each two adjacent heads may be the same.

For example, if the value of N is 4, different global patterns may be configured for the 1^{st} head, the 2^{nd} head, the 3^{rd} head and the 4^{th} head respectively. That is, global patterns corresponding to any two heads may be different.

With the above processing, the connectivity between the tokens may be further improved, thereby further improving the model performance and the text processing effect.

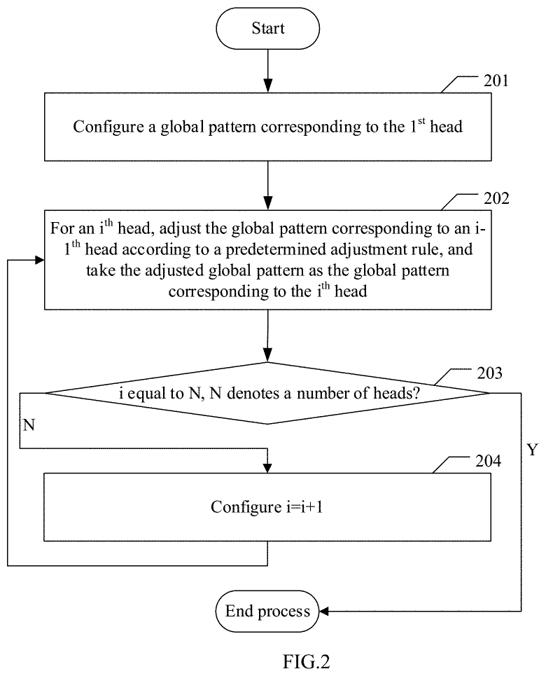

In one embodiment of the present disclosure, a specific implementation of configuring different global patterns corresponding to the heads respectively may be shown in FIG. 2.

FIG. 2 is a flowchart of an embodiment of a method for configuring global patterns corresponding to heads respectively according to the present disclosure. As shown in FIG. 2, the method may specifically the following implementation.

In step 201, a global pattern corresponding to the 1^{st} head is configured.

The specific form of the global pattern is not limited.

In step 202, for the i^{th} head, the global pattern corresponding to an i−1^{th} head is adjusted according to a predetermined adjustment rule, and the adjusted global pattern is taken as the global pattern corresponding to the i^{th} head.

An initial value of i is 2.

In addition, the predetermined adjustment rule is not specifically limited.

In step 203, it is determined whether i is equal to N, where N denotes a number of heads; if yes, the process is ended; and otherwise, step 204 is performed.

If i is equal to N, which indicates that all the heads have been configured, correspondingly, the process may be ended; and otherwise, processing is continued for next head.

In step 204, i=i+1 is configured, and then step 202 is repeated.

That is, 1 may be added to the value of i to obtain an updated i, and step 202 is repeated for the i^{th} head.

Assuming that the value of N is 4, global patterns corresponding to the heads may be sequentially obtained according to the method in the embodiment shown in FIG. 2.

As can be seen, after the global pattern is configured according to the above method, a change rule between the global patterns corresponding to each two adjacent heads is the same, enabling more tokens to have a chance to become global tokens. Moreover, the global patterns corresponding to the heads may be quickly and efficiently configured through regular adjustment.

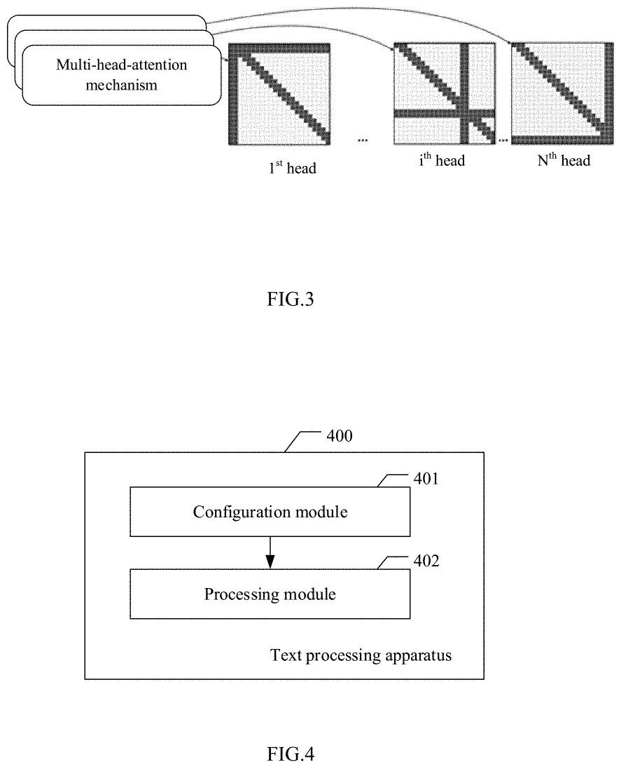

As an example, FIG. 3 is a schematic diagram of attention patterns corresponding to different heads according to the present disclosure.

As shown in FIG. 3, the heads may correspond to a same local pattern, but correspond to different global patterns. The local pattern shown in FIG. 3 is a pattern in the prior art.

As shown in FIG. 3, a large square represents an attention matrix. Assuming that the to-be-processed text includes 10 (which is only exemplary) tokens, the attention matrix may include 10 small squares in length and width directions respectively. Each small square corresponds to one token.

As shown in FIG. 3, taking the 1^{st} head as an example, where a diagonal line formed by small dark squares represents a local pattern, and a horizontal line and a vertical line formed by small dark squares represent a global pattern.

As can be seen, for the i^{th} head, 1≤i≤N, and as i constantly increases, the corresponding global pattern shows regular changes. As shown in FIG. 3, the corresponding horizontal and vertical lines move regularly, and the manner of each movement, that is, amplitude of each movement, is the same. If the global pattern corresponding to the 1^{st} head and the global pattern corresponding to the N^{th} head are shown in FIG. 3 respectively, the amplitude of each movement may depend on the value of N.

Correspondingly, taking the 1^{st} head as an example, as shown in FIG. 3, receptive fields of the tokens are as shown below respectively:

As described above, each small square may correspond to one token respectively. Assuming that the tokens are numbered as token1, token2, token3 . . . , and token M from top to bottom, where M denotes a number of the tokens, for token1, its receptive field is global, that is, including all the tokens; for token2, its receptive field is also global, that is, the same as token1, including all the tokens; for token3, its receptive field includes 5 tokens, namely token1, token2, token3, token4 and token5; for token4, its receptive field includes 5 tokens, namely token1, token2, token4, token5 and token6; for token5, its receptive field includes 5 tokens, namely token1, token2, token5, token6 and token1.

Refer to FIG. 3 for the receptive fields of other tokens, which are not repeated one by one.

Pre-processing, such as machine translation or emotion recognition, for the to-be-processed text may be realized by means of the Transformer model according to the present disclosure. For example, semantic expression coding or the like may be performed by using the Transformer model. A specific implementation is the prior art.

After the attention patterns corresponding to the heads are configured based on the method according to the present disclosure, the performance of the Transformer model is improved. Then, correspondingly, text processing by using the Transformer model may improve a text processing effect. For example, the accuracy of machine translation or the accuracy of emotion recognition results may be improved.

It is to be noted that, to make the description brief, the foregoing method embodiments are expressed as a series of actions. However, those skilled in the art should appreciate that the present disclosure is not limited to the described action sequence, because according to the present disclosure, some steps may be performed in other sequences or performed simultaneously. Next, those skilled in the art should also appreciate that all the embodiments described in the specification are preferred embodiments, and the related actions and modules are not necessarily mandatory to the present disclosure. Besides, for a part that is not described in detail in one embodiment, refer to related descriptions in other embodiments.

The above is an introduction to the method embodiments. The solution according to the present disclosure is further illustrated below through apparatus embodiments.

FIG. 4 is a schematic structural diagram of composition of an embodiment of a text processing apparatus 400 according to the present disclosure. As shown in FIG. 4, the apparatus includes a configuration module 401 and a processing module 402.

The configuration module 401 is configured to configure, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1.

The processing module 402 is configured to process the text by using the

Transformer model.

As can be seen, in the solution of the above apparatus embodiment, the heads no longer adopt the same attention pattern, but different heads may correspond to different attention patterns, so as to improve connectivity between tokens, thereby improving the model performance and correspondingly improving the text processing effect.

The specific value of N may be determined according to an actual requirement. The configuration module 401 may configure corresponding attention patterns for N heads respectively. At least one head corresponds to a different attention pattern from the other N−1 heads. That is, N attention patterns corresponding to the N heads include at least two different attention patterns.

In one embodiment of the present disclosure, the attention pattern may include: a local pattern and a global pattern. That is, the attention pattern may be composed of a local pattern and a global pattern.

In one embodiment of the present disclosure, the configuration module 401 may configure a same local pattern for the heads. That is, a uniform local pattern may be configured for the heads. In this way, an effect of configuring different attention patterns may be achieved only by configuring different global patterns for any two heads.

In one embodiment of the present disclosure, the configuration module 401 may configure different global patterns corresponding to the heads respectively, wherein a change rule between the global patterns corresponding to each two adjacent heads may be the same.

In one embodiment of the present disclosure, the configuration module 401 may configure a global pattern corresponding to the 1^{st} head; perform the following processing for an i^{th} head, an initial value of i being 2: adjusting the global pattern corresponding to an i−1^{th} head according to a predetermined adjustment rule, and taking the adjusted global pattern as the global pattern corresponding to the i^{th} head; and end the processing if i is determined to be equal to N, and otherwise, configure i=i+1, and repeat the first processing for the i^{th} head.

Assuming that the value of N is 4, a global pattern corresponding to the 1^{st} head may be configured; then, for the 2^{nd} head, the global pattern corresponding to the 1^{st} head may be adjusted according to the predetermined adjustment rule, and the adjusted global pattern is taken as the global pattern corresponding to the 2^{nd} head. Then, for the 3^{rd} head, the global pattern corresponding to the 2^{nd} head may be adjusted according to the predetermined adjustment rule, and the adjusted global pattern is taken as the global pattern corresponding to the 3^{rd} head. Then, for the 4^{th} head, the global pattern corresponding to the 3^{rd} head may be adjusted according to the predetermined adjustment rule, and the adjusted global pattern is taken as the global pattern corresponding to the 4^{th} head.

Upon completion of the above processing, the processing module 402 may realize pre-processing, such as machine translation or emotion recognition, for the to-be-processed text by means of the Transformer model. For example, semantic expression coding or the like may be performed by using the Transformer model.

A specific work flow of the apparatus embodiment shown in FIG. 4 may be obtained with reference to the relevant descriptions in the above method embodiment, which is not described in detail.

After the attention patterns corresponding to the heads are configured based on the method according to the present disclosure, the performance of the Transformer model is improved. Then, correspondingly, text processing by using the Transformer model may improve a text processing effect. For example, the accuracy of machine translation or the accuracy of emotion recognition results may be improved.

Acquisition, storage and application of users' personal information involved in the technical solutions of the present disclosure comply with relevant laws and regulations, and do not violate public order and moral.

The solutions according to the present disclosure may be applied to the field of artificial intelligence, and in particular, relate to the fields such as deep learning and natural language processing. Artificial intelligence is a discipline that studies how to make computers simulate certain thinking processes and intelligent behaviors (such as learning, reasoning, thinking and planning) of human beings, which includes hardware technologies and software technologies. The artificial intelligence hardware technologies generally include sensors, dedicated artificial intelligence chips, cloud computing, distributed storage, big data processing and other technologies. The artificial intelligence software technologies mainly include a computer vision technology, a speech recognition technology, a natural language processing technology, machine learning/deep learning, a big data processing technology, a knowledge graph technology and other major directions.

According to embodiments of the present disclosure, the present disclosure further provides an electronic device, a readable storage medium and a computer program product.

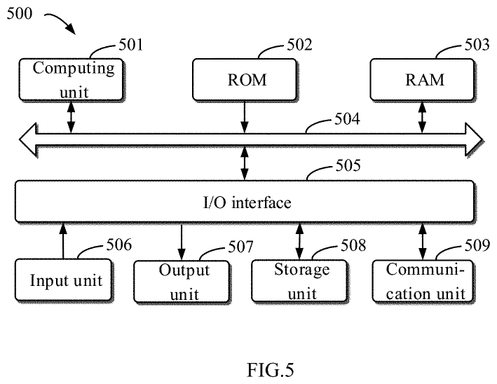

FIG. 5 is a schematic block diagram of an electronic device 500 configured to implement embodiments of the present disclosure. The electronic device is intended to represent various forms of digital computers, such as laptops, desktops, workbenches, servers, blade servers, mainframe computers and other suitable computing devices. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementation of the present disclosure as described and/or required herein.

As shown in FIG. 5, the device 500 includes a computing unit 501, which may perform various suitable actions and processing according to a computer program stored in a read-only memory (ROM) 502 or a computer program loaded from a storage unit 508 into a random access memory (RAM) 503. The RAM 503 may also store various programs and data required to operate the device 500. The computing unit 501, the ROM 502 and the RAM 503 are connected to one another by a bus 504. An input/output (I/O) interface 505 is also connected to the bus 504.

A plurality of components in the device 500 are connected to the I/O interface 505, including an input unit 506, such as a keyboard and a mouse; an output unit 507, such as various displays and speakers; a storage unit 508, such as disks and discs; and a communication unit 509, such as a network card, a modem and a wireless communication transceiver. The communication unit 509 allows the device 500 to exchange information/data with other devices over computer networks such as the Internet and/or various telecommunications networks.

The computing unit 501 may be a variety of general-purpose and/or special-purpose processing components with processing and computing capabilities. Some examples of the computing unit 501 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 501 performs the methods and processing described above, such as the method according to the present disclosure. For example, in some embodiments, the method according to the present disclosure may be implemented as a computer software program that is tangibly embodied in a machine-readable medium, such as the storage unit 508. In some embodiments, part or all of a computer program may be loaded and/or installed on the device 500 via the ROM 502 and/or the communication unit 509. One or more steps of the method according to the present disclosure may be performed when the computer program is loaded into the RAM 503 and executed by the computing unit 501. Alternatively, in other embodiments, the computing unit 501 may be configured to perform the method according to the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN) and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the protection scope of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the protection scope of the present disclosure.

What is claimed is:

1. A text processing method, comprising:
configuring, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1; and
processing the text by using the Transformer model.

2. The method according to claim 1, wherein the attention pattern comprises: a local pattern and a global pattern.

3. The method according to claim 2, wherein the step of configuring attention patterns corresponding to heads in a Transformer model using a multi-head-attention mechanism comprises: configuring a same local pattern corresponding to the heads.

4. The method according to claim 2, wherein the step of configuring attention patterns corresponding to heads in a Transformer model using a multi-head-attention mechanism comprises:
configuring different global patterns corresponding to the heads respectively, wherein a change rule between the global patterns corresponding to each two adjacent heads is the same.

5. The method according to claim 3, wherein the step of configuring attention patterns corresponding to heads in a Transformer model using a multi-head-attention mechanism comprises:
configuring different global patterns corresponding to the heads respectively, wherein a change rule between the global patterns corresponding to each two adjacent heads is the same.

6. The method according to claim 4, wherein the step of configuring different global patterns corresponding to the heads respectively comprises:
configuring a global pattern corresponding to the 1^{st} head;
performing the following processing for an i^{th} head, an initial value of i being 2;
adjusting the global pattern corresponding to an i−1^{th} head according to a predetermined adjustment rule, and taking the adjusted global pattern as the global pattern corresponding to the i^{th} head; and
ending the processing if i is determined to be equal to N, and otherwise, configuring i=i+1, and repeating the first processing for the i^{th} head.

7. The method according to claim 5, wherein the step of configuring different global patterns corresponding to the heads respectively comprises:
configuring a global pattern corresponding to the 1^{st} head;
performing the following processing for an i^{th} head, an initial value of i being 2;
adjusting the global pattern corresponding to an i−1^{th} head according to a predetermined adjustment rule, and taking the adjusted global pattern as the global pattern corresponding to the i^{th} head; and
ending the processing if i is determined to be equal to N, and otherwise, configuring i=i+1, and repeating the first processing for the i^{th} head.

8. An electronic device, comprising:
at least one processor; and
a memory communicatively connected with the at least one processor;
wherein the memory stores instructions executable by the at least one processor, and the instructions are executed by the at least one processor to enable the at least one processor to perform a text processing method, wherein the text processing method comprises:
configuring, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1; and
processing the text by using the Transformer model.

9. The electronic device according to claim 8, wherein the attention pattern comprises: a local pattern and a global pattern.

10. The apparatus according to claim 9, wherein the step of configuring attention patterns corresponding to heads in a Transformer model using a multi-head-attention mechanism comprises: configuring a same local pattern for the heads.

11. The electronic device according to claim 9, wherein the step of configuring attention patterns corresponding to heads in a Transformer model using a multi-head-attention mechanism comprises: configuring different global patterns corresponding to the heads respectively, wherein a change rule between the global patterns corresponding to each two adjacent heads is the same.

12. The electronic device according to claim 10, wherein the step of configuring attention patterns corresponding to heads in a Transformer model using a multi-head-attention mechanism comprises:
configuring different global patterns corresponding to the heads respectively, wherein a change rule between the global patterns corresponding to each two adjacent heads is the same.

13. The electronic device according to claim 11, wherein the step of configuring different global patterns corresponding to the heads respectively comprises:
configuring a global pattern corresponding to the 1^{st} head; performing the following processing for an i^{th} head, an initial value of i being 2: adjusting the global pattern corresponding to an i−1^{th} head according to a predetermined adjustment rule, and taking the adjusted global pattern as the global pattern corresponding to the i^{th} head; and ending the processing if i is determined to be equal to N, and otherwise, configures i=i+1, and repeats the first processing for the i^{th} head.

14. The electronic device according to claim 12, wherein the step of configuring different global patterns corresponding to the heads respectively comprises:
configuring a global pattern corresponding to the 1^{st} head; performing the following processing for an i^{th} head, an initial value of i being 2; adjusting the global pattern corresponding to an i−1^{th} head according to a predetermined adjustment rule, and taking the adjusted global pattern as the global pattern corresponding to the i^{th} head; and ending the processing if i is determined to be equal to N, and otherwise, configures i=i+1, and repeats the first processing for the i^{th} head.

15. A non-transitory computer readable storage medium with computer instructions stored thereon, wherein the computer instructions are used for causing a computer to perform a text processing method, wherein the text processing method comprises:
configuring, for a to-be-processed text, attention patterns corresponding to heads in a Transformer model using a multi-head-attention mechanism respectively, wherein at least one head corresponds to a different attention pattern from the other N−1 heads, and N denotes a number of heads and is a positive integer greater than 1; and
processing the text by using the Transformer model.

16. The non-transitory computer readable storage medium according to claim 15, wherein the attention pattern comprises: a local pattern and a global pattern.

17. The non-transitory computer readable storage medium according to claim 16, wherein the step of configuring attention patterns corresponding to heads in a Transformer model using a multi-head-attention mechanism comprises: configuring a same local pattern corresponding to the heads.

18. The non-transitory computer readable storage medium according to claim 16, wherein the step of configuring attention patterns corresponding to heads in a Transformer model using a multi-head-attention mechanism comprises:
configuring different global patterns corresponding to the heads respectively, wherein a change rule between the global patterns corresponding to each two adjacent heads is the same.

19. The non-transitory computer readable storage medium according to claim 17, wherein the step of configuring attention patterns corresponding to heads in a Transformer model using a multi-head-attention mechanism comprises:
configuring different global patterns corresponding to the heads respectively, wherein a change rule between the global patterns corresponding to each two adjacent heads is the same.

20. The non-transitory computer readable storage medium according to claim 18, wherein the step of configuring different global patterns corresponding to the heads respectively comprises:
configuring a global pattern corresponding to the 1^{st} head;
performing the following processing for an i^{th} head, an initial value of i being 2;
adjusting the global pattern corresponding to an i−1^{th} head according to a predetermined adjustment rule, and taking the adjusted global pattern as the global pattern corresponding to the i^{th} head; and
ending the processing if i is determined to be equal to N, and otherwise, configuring i=i+1, and repeating the first processing for the i^{th} head.
